(19) United States
(12) Patent Application Publication
(10) Pub. No.: US 2026/0120944 A1
(43) Pub. Date: Apr. 30, 2026

(54) A TRANSFORMER ARRANGEMENT

(71) Applicant: Hitachi Energy Ltd, Zürich (CH)

(72) Inventors: Erik LYSELL, Ludvika (SE); Erik Carl WEDIN, Karlstad (SE); Peter ASTRAND, Bälinge (SE)

(21) Appl. No.: 19/478,515

(22) PCT Filed: Apr. 26, 2024
(86) PCT No.: PCT/EP2024/061648

§ 371 Date: Oct. 24, 2025

(30) Foreign Application Priority Data
Apr. 27, 2023 (EP) 23170439.6

(51) Int. Cl. H01F 27/30; H01F 27/24

(52) U.S. Cl. CPC H01F 27/306; H01F 27/24

(57) ABSTRACT

A transformer arrangement having a transformer including a transformer core, which includes a bottom yoke and a top yoke interconnected by at least one limb extending along a first axis. At least a first winding and a second winding are coaxially arranged around the at least one limb. An auxiliary winding is arranged around the at least one limb, positioned axially between the first and second windings, and the bottom yoke or the top yoke. The auxiliary winding is magnetically coupled to the at least first winding and/or the second winding. The transformer arrangement further includes a series reactor connected to the auxiliary winding, and at least one support element positioned between an axial end of the first and second windings and the bottom yoke and/or the top yoke, wherein the auxiliary winding is supported by the support element, and at least partially embedded in the support element.

### CROSS REFERENCE TO RELATED APPLICATIONS

This application is a 35 U.S.C. § 371 national stage application of PCT International Application No. PCT/EP2024/061648 filed on Apr. 26, 2024, which in turn claims priority to EP Patent Application No. 23170439.6, filed on Apr. 27, 2023, the disclosures and content of which are incorporated by reference herein in their entireties.

### TECHNICAL FIELD

The present disclosure relates to a transformer arrangement having an auxiliary winding. In particular, the disclosure relates to limiting short-circuit currents in such auxiliary windings.

### BACKGROUND

In conventional transformers, when auxiliary power is needed, an auxiliary winding such as a tertiary winding may be coaxially arranged with the main windings, i.e. with the primary and secondary windings. See FIG. 1. The auxiliary winding may for instance be used to supply power to devices at a transformer station, such as lighting, heating and cooling at the transformer station. Auxiliary windings are particularly useful in remote places which lack access to regular grid power. Tertiary winding arrangements add to the radial size of the transformer windings and to the transformer as a whole. It also adds to the cost of the transformer. Another type of auxiliary winding is a yoke winding, i.e. an auxiliary winding arranged around a yoke of the transformer. As an auxiliary winding, such a yoke winding is smaller, lighter and less expensive when compared to a coaxial tertiary winding.

Yoke windings have traditionally had a voltage level below 1 kV which may be considered a low voltage application. Lately, yoke windings have been used at around 7 kV, which may be considered a medium voltage application. In medium voltage applications a cabinet external to the transformer is required. The cabinet comprises a fuse protecting the auxiliary winding from high short-circuit currents since the auxiliary winding is not inherently short-circuit proof. However, external cabinets require extra work and maintenance on site.

### SUMMARY

Therefore, an object of the disclosure is to provide an improved transformer arrangement having an auxiliary winding which is protected from damaging short-circuit currents. In particular, the auxiliary winding is a yoke winding and the transformer arrangement does not require a cabinet.

According to a first aspect of the present disclosure, the object is at least partly achieved by a transformer arrangement according to claim 1.

Hence, there is provided a transformer arrangement having at least one transformer comprising a transformer core, which comprises a bottom yoke and a top yoke interconnected by at least one limb extending along a first axis. The transformer arrangement further comprises at least a first winding and a second winding coaxially arranged around the at least one limb. Further, an auxiliary winding is arranged around the at least one limb and is positioned axially between the first and second windings, and the bottom yoke or the top yoke. The auxiliary winding is magnetically coupled to the at least first winding and/or the second winding. The transformer arrangement further comprises a series reactor connected to the auxiliary winding, and at least one support element positioned between an axial end of the first and second windings and the bottom yoke and/or the top yoke. The auxiliary winding may be supported by the support element and at least partially embedded in the support element.

The first axis may be substantially vertically aligned. The auxiliary winding is positioned around the limb between an axial end of the first and second windings and the top or bottom yoke, i.e. axially between the first and second windings and the top or bottom yoke. The auxiliary winding is positioned such that it is magnetically coupled to the first and second windings and configured deliver a part of the power of the main windings to at least one auxiliary device.

When the transformer is a multi-phase transformer, such as a three-phase transformer, the transformer comprises multiple limbs, e.g. one limb per phase. Each limb may be provided with an auxiliary winding, resulting in a three-phase power supply for auxiliary equipment and devices. Obviously, each auxiliary winding may be connected to a respective series reactor.

The series reactor comprises at least one impedance element connected in series with the auxiliary winding. The reactor is passive during normal operation of the auxiliary winding. At the occurrence of a short-circuit event in the auxiliary winding, a suddenly increased current through the reactor generates a magnetic field which induces an opposed current in the reactor, which in turn reduces and limits the short-circuit current.

The support element is an element configured to mechanically support the windings. The support element may be formed of an electrically insulating material and may be in physical contact with the windings. The support element may for example be a so-called common spacer ring.

In case the auxiliary winding is positioned below an axial lower end of the first and second windings, the support element may be supported on the bottom yoke and the auxiliary winding may be supported by the support element on an upper side of the support element.

In case the auxiliary winding is positioned above an axial upper end of the first and second windings, the auxiliary winding may be supported by the support element on an upper side of the support element.

Optionally, the auxiliary winding is configured to deliver auxiliary power from the transformer via the series reactor to at least one auxiliary device.

The auxiliary winding is magnetically coupled to the first and second windings of the transformer. Power may thereby be generated in the auxiliary winding and delivered to auxiliary devices and equipment. Such devices and equipment may be power consumers used locally at a transformer station, e.g. devices for lighting, heating and/or cooling, such as when the transformer station is in a remote location and is not connected to a grid which could supply the devices. The auxiliary winding is dimensioned and configured to deliver power at a voltage level suitable for the auxiliary devices.

Optionally, the support element is a ring comprising an annular groove or cavity, which annular groove or cavity circumscribes the limb. The auxiliary winding may be arranged in the annular groove or cavity.

As such, the auxiliary winding is assembled with the transformer without increasing its size, since the auxiliary winding is housed in an existing component, i.e. in the groove or cavity of the support element. In the case of a groove, the auxiliary winding is arranged, in the groove, partially embedded, in the support element. In the case of a cavity, the auxiliary winding may be completely embedded and enclosed in the support element,

Optionally, a rated power of at least the first winding or the second winding is above 100 MVA and the rated voltage of at least the first winding or the second winding is above 66 kV.

Optionally, the auxiliary winding has a rated voltage above 1 kV.

Optionally, an impedance of the series reactor is configured to limit short-circuit currents in the auxiliary winding below 30kA rms.

Optionally, the at least one transformer is a three-phase transformer or three single-phase transformers and wherein three auxiliary windings, each connected to a respective series reactor, are connected in star configuration or in delta configuration.

The star connection is also known as Y connection or wye connection.

Optionally, the transformer arrangement further comprises a transformer tank, wherein the transformer is enclosed in the transformer tank and is immersed in oil in the transformer tank.

Optionally, the series reactor is located inside the transformer tank. Thereby the series reactor does not add to the size of the transformer, as opposed to a conventional medium voltage cabinet for short-circuit current protection, as discussed in the background section herein above. Terminals of any auxiliary windings may be led to the outside of the transformer tank. A star or delta configuration of the auxiliary windings may be connected inside the transformer tank enclosing a three-phase transformer. In case of three single-phase transformers, each transformer enclosed in a respective transformer tank, the star or delta configuration of the auxiliary windings is connected outside the transformer tanks.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Further objects and advantages of, and features of the disclosure will be apparent from the following description of one or more embodiments, with reference to the appended drawings, where:

FIG. 1 shows cross-sectional view of a prior art transformer arrangement comprising a tertiary winding as an auxiliary winding.

FIG. 2 shows a cross-sectional view of a transformer arrangement according to a first aspect of the present disclosure.

FIG. 3 shows a cross-sectional view of a transformer arrangement according to an embodiment of the present disclosure.

FIG. 4 conceptually shows an exemplary three-phase transformer according to an embodiment the present disclosure.

FIG. 5 shows an example of an embodiment of the present disclosure for a transformer connected in delta configuration.

FIG. 6 shows an example of an embodiment of the present disclosure for a transformer connected in star configuration.

### DETAILED DESCRIPTION OF EXAMPLE EMBODIMENTS OF THE DISCLOSURE

The present disclosure is developed in more detail below referring to the appended drawings which show examples of embodiments. The disclosure should not be viewed as limited to the described examples of embodiments. Like numbers refer to like elements throughout the description.

The terminology used herein is for the purpose of describing particular aspects of the disclosure only and is not intended to limit the disclosure. As used herein, the singular forms “a”, “an” and “the” are intended to include the plural forms as well, unless the context clearly indicates otherwise. Unless otherwise defined, all terms (including technical and scientific terms) used herein have the same meaning as commonly understood by one of ordinary skill in the art to which this disclosure belongs.

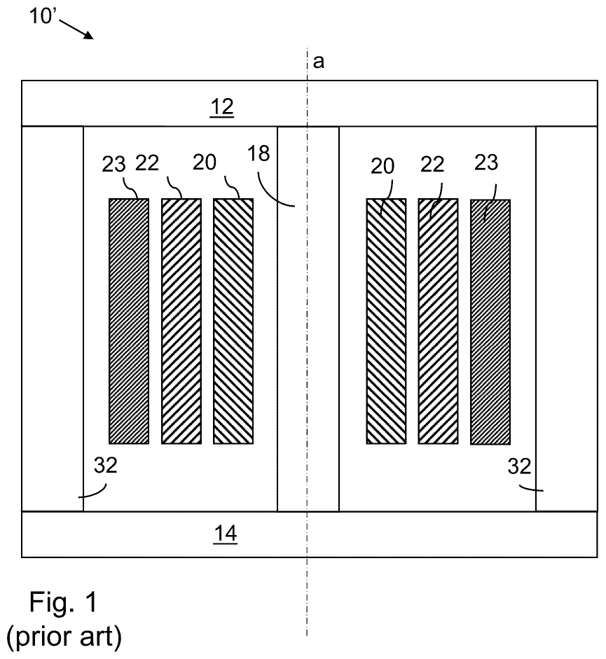

FIG. 1 illustrates a cross-sectional view of a prior art transformer 10′ comprising a transformer core 12 having a bottom yoke 14 and a top yoke 16 interconnected by a limb 18 extending along a first axis a. A inner first winding 20 and an outer second winding 22 are coaxially arranged around the limb 18. An auxiliary winding 23 in the form of a tertiary winding is coaxially arranged with the first and second windings 20, 22, around the limb 18. The auxiliary/tertiary winding 23 is magnetically coupled to the at least first winding 20 and/or the second winding 22. A tertiary winding 23, such as shown in FIG. 1, may be designed to withstand short-circuit currents.

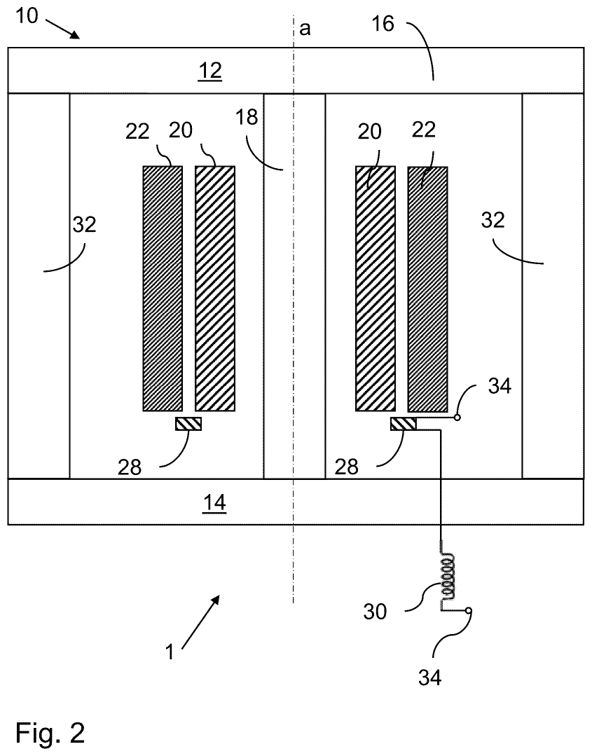

According to an aspect of the present disclosure, the tertiary winding 23 as an auxiliary winding may be replaced by a yoke winding 28, as shown in FIG. 2. The yoke winding is attractive in that it is smaller, lighter and less expensive than a tertiary winding 23 which is conventionally arranged coaxially with the first and second windings 20, 22.

The yoke winding 28 has previously required a cabinet (not shown) comprising fuses to protect the yoke winding 28 from damaging short-circuit currents. Adding a cabinet to transformer consumes space at a transformer station, where space is usually restricted. In addition, the cost of cabinets has increased significantly, making the yoke winding an unattractive solution as an auxiliary winding.

The present disclosure makes the cabinet unnecessary and results in a transformer arrangement 1 comprising a transformer 10 having an auxiliary winding 28, which transformer arrangement 1 smaller or similar in size to a conventional transformer 10′ having a tertiary winding.

FIG. 2 shows the transformer arrangement 1 having at least one transformer 10.

The transformer arrangement comprises a transformer core 12 comprising a bottom yoke 14 and a top yoke 16 interconnected by at least one limb (18) extending along a first axis a. At least a first winding 20 and a second winding 22 are coaxially arranged around the at least one limb 18. An auxiliary winding 28 is arranged around the at least one limb 18, positioned axially between the first and second windings 20, 22, and the bottom yoke 14 or the top yoke 16. The auxiliary winding is magnetically coupled to the at least first winding 20 and/or the second winding 22. The transformer arrangement 1 further comprises a series reactor 30 connected to the auxiliary winding 28.

The first axis a may be substantially vertically aligned. The auxiliary winding 28 is positioned around the limb 18 between an axial end of the first and second windings 20, 22 and the top yoke 16 or bottom yoke 14, i.e. axially between the first and second windings 20, 22 and the top yoke 16 or bottom yoke 14. The auxiliary winding 18 is positioned such that it is magnetically coupled to the first and second windings 20, 22 and configured deliver a part of the power of the main windings (the first and second windings 20, 22) to at least one auxiliary device (not shown).

When the transformer 10 is a multi-phase transformer 10, such as a three-phase transformer 10, the transformer 10 comprises multiple limbs 18, e.g. one limb per phase 18. Each limb 18 may be provided with an auxiliary winding 28, resulting in a three-phase power supply for auxiliary equipment and devices. Each auxiliary winding 28 may be connected to a respective series reactor 30.

The series reactor 30 comprises at least one impedance element connected in series with the auxiliary winding. The series reactor is passive during normal operation of the auxiliary winding 28. At the occurrence of a short-circuit event in the auxiliary winding 28, a suddenly increased current through the series reactor 30 generates a magnetic field which induces an opposed current in the series reactor 30, which in turn reduces and limits the short-circuit current in both the series reactor and, more importantly, in the auxiliary winding 28.

The auxiliary winding 28 may be configured to deliver auxiliary power from the transformer 10 via the series reactor 30 to at least one auxiliary device via terminals 34. The auxiliary winding 28 is magnetically coupled to the first and second windings 20, 22 of the transformer 10. Power may thereby be generated in the auxiliary winding 28 and delivered to auxiliary devices and equipment. Such devices and equipment may be power consumers used locally at a transformer station, e.g. devices for lighting, heating and/or cooling, such as when the transformer station is in a remote location and is not connected to a grid which could supply the devices. The auxiliary winding 28 is dimensioned and configured to deliver power at a voltage level suitable for such auxiliary devices.

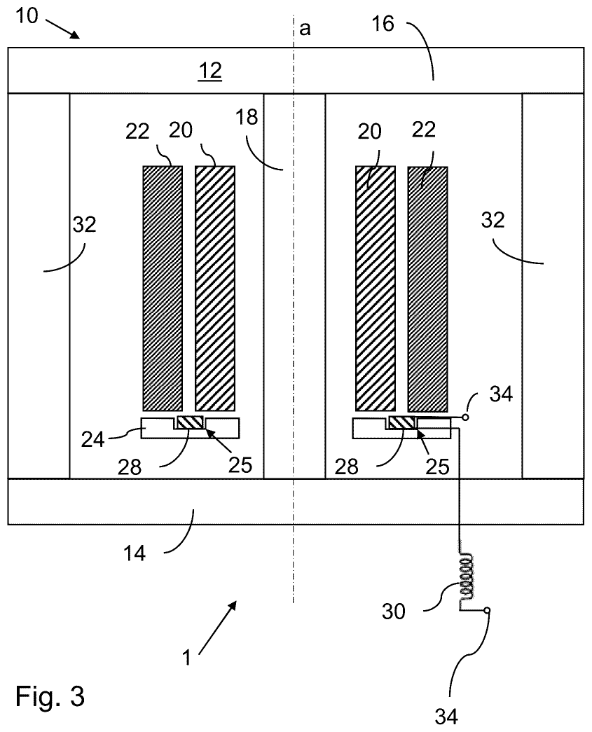

FIG. 3 illustrates that the transformer arrangement 1 may further comprise at least one support element 24 positioned between an axial end of the first and second windings 20, 22 and the bottom yoke 14 and/or the top yoke 16. The auxiliary winding 28 may be supported by the support element 24.

The support element 24 is an element configured to mechanically support the first and second windings 20, 22. The support element 24 may be formed of an electrically insulating material and may be in physical contact with the first and second windings 20, 22. The support element 24 may for example be a so-called common spacer ring 24.

In case the auxiliary winding 28 is positioned below an axial lower end of the first and second windings 20, 22, the support element 24 may be supported on the bottom yoke 14 and the auxiliary winding 28 may be supported by the support element 24 on an upper side of the support element 24.

In case the auxiliary winding 28 is positioned above an axial upper end of the first and second windings 20, 22, the auxiliary winding 28 may be supported by the support element 24 on an upper side of the support element 24.

The support element may be a ring 24 comprising an annular groove or cavity 25, which annular groove or cavity 25 circumscribes the limb 18. The auxiliary winding 28 may be arranged in the annular groove or cavity 25. The auxiliary winding 28 may thereby be assembled with the transformer 10 without increasing the size of the transformer 10, since the auxiliary winding 28 is housed in an existing component, i.e. in the groove or cavity 25 of the support element 24. In the case of a groove, the auxiliary winding 28 is arranged, in the groove, partially embedded, in the support element 24. In the case of a cavity, the auxiliary winding 28 may be completely embedded and enclosed in the support element 24, When the at least one auxiliary winding 28 is used for medium voltage applications, a rated power of the at least one first winding 20 or the second winding 22 is above 100 MVA and the rated voltage of at least the first winding 20 or the second winding 22 is above 66 kV. The auxiliary winding has a rated voltage above 1 kV. In order to protect the auxiliary winding 28 from damage due to short-circuit currents, an impedance of the series reactor 30 is preferably configured to limit short-circuit currents in the auxiliary winding 28 below 30 kA rms.

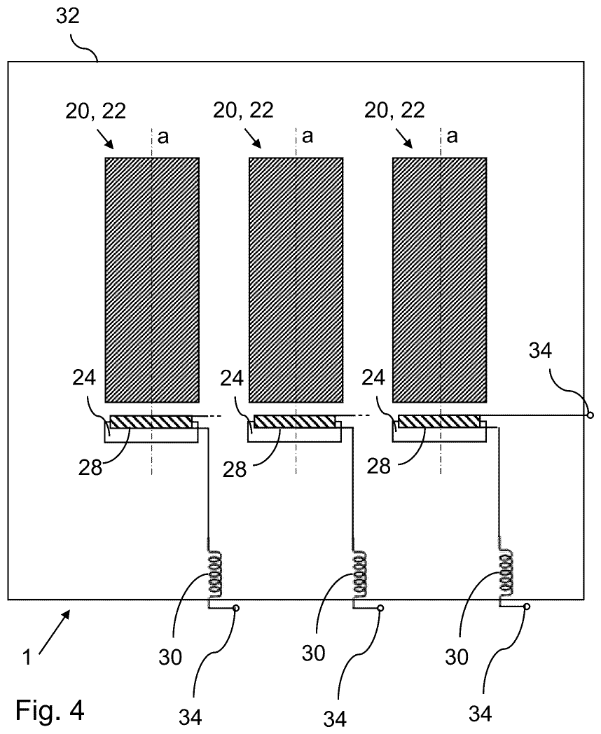

FIG. 4 conceptually shows the transformer arrangement 1 comprising a three-phase transformer 10. As shown, a multi-phase transformer 10 may have an auxiliary winding 28 arranged around each limb 18. The limbs 18 are not shown in FIG. 4, but it is to be understood that a first and second windings 20, 22 are arranged on a respective limb 18 for each phase of the transformer 10. In addition, and in accordance with the present disclosure, each auxiliary winding 28 has a series reactor 30 connected in series.

The transformer arrangement 1 may further comprise a transformer tank 32, and the transformer 10 may be enclosed in the transformer tank 32 and be immersed in insulating oil in the transformer tank 32. The series reactor 30 may be located inside the transformer tank 32. Thereby the series reactor 30 does not add to the size of the transformer 10, as opposed to a conventional medium voltage cabinet for short-circuit current protection, as discussed in the background section herein above. Terminals 34 of any auxiliary windings 28 may be led to the outside of the transformer tank 32.

As is known in the art, three-phase transformers 10 may be connected in star configuration or delta configuration. Auxiliary windings 28, each connected to a respective series reactor 30, of such three-phase configurations may correspondingly be connected in star configuration or delta configuration.

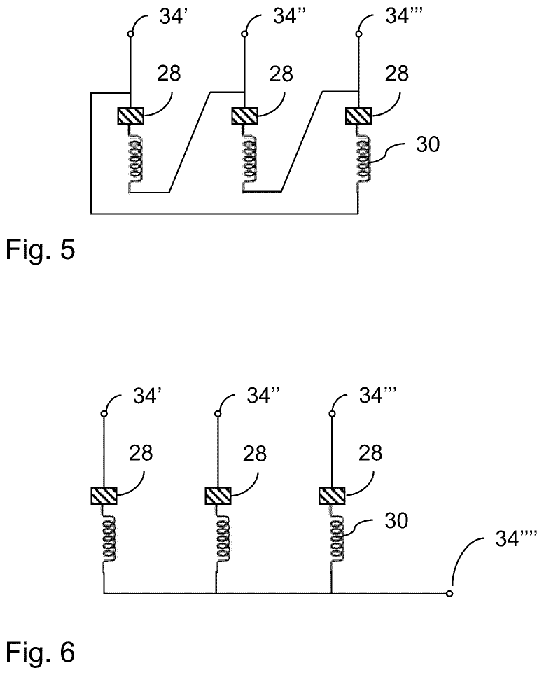

FIG. 5 shows three auxiliary windings 28 of a three-phase transformer arrangement 1, which auxiliary windings 28 are connected in delta configuration. Terminals 34′, 34″, 34″′ indicate terminals for the three phases which may be connected to deliver power to auxiliary systems.

FIG. 6 shows three auxiliary windings 28 of a three-phase transformer arrangement 1, which auxiliary windings 28 are connected in star configuration. Terminals 34′, 34″, 34″′ indicate terminals for the three phases which may be connected to deliver power to auxiliary systems. Terminal 34″″ illustrate the neutral point of the star configuration. As stated above, the star configuration is also known as a Y configuration or a wye configuration.

1. A transformer arrangement having at least one transformer comprising:
a transformer core comprising a bottom yoke and a top yoke interconnected by at least one limb extending along a first axis,
at least a first winding and a second winding coaxially arranged around the at least one limb,
an auxiliary winding arranged around the at least one limb, positioned axially between the first and second windings, and the bottom yoke or the top yoke, the auxiliary winding being magnetically coupled to the at least first winding and/or the second winding, and
wherein the transformer arrangement further comprises a series reactor connected to the auxiliary winding, and at least one support element positioned between an axial end of the first and second windings and the bottom yoke and/or the top yoke, wherein the auxiliary winding is supported by the support element, and at least partially embedded in the support element.

2. The transformer arrangement according to claim 1, wherein the auxiliary winding is configured to deliver auxiliary power from the transformer via the series reactor to at least one auxiliary device.

3. The transformer arrangement according to claim 1, wherein the support element is a ring comprising an annular groove or cavity, which annular groove or cavity circumscribes the limb, and wherein the auxiliary winding is arranged in the annular groove or cavity.

4. The transformer arrangement according to claim 1, where a rated power of at least the first winding or the second winding is above 100 MVA and the rated voltage of the first winding and wherein a rated voltage of at least the first winding or the second winding is above 66 kV.

5. The transformer arrangement according to claim 1, wherein the auxiliary winding has a rated voltage above 1 kV.

6. The transformer arrangement according to claim 1, wherein an impedance of the series reactor is configured to limit short-circuit currents in the auxiliary winding below 30 kA rms.

7. The transformer arrangement according to claim 1, wherein the at least one transformer is a three-phase transformer or three single-phase transformers and wherein three auxiliary windings, each connected to a respective series reactor, are connected in star configuration or in delta configuration.

8. The transformer arrangement according to claim 1, further comprising a transformer tank, wherein the transformer is enclosed in the transformer tank and is immersed in oil in the transformer tank.

9. The transformer arrangement according to claim 8, wherein the series reactor is located inside the transformer tank.
